(19) United States
(12) Patent Application Publication
(10) Pub. No.: US 2020/0010595 A1
(43) Pub. Date: Jan. 9, 2020

(54) Polar Functionalized Hydrocarbon Resin Via Post-Reactor Modification

(71) Applicant: ExxonMobil Chemical Patents Inc., Baytown, TX (US)

(72) Inventors: Ranjan Tripathy, Sugar Land, TX (US); Jason A. Mann, Houston, TX (US); Edward J. Blok, Huffman, TX (US); Thomas R. Barbee, Kingwood, TX (US)

(21) Appl. No.: 16/491,260

(22) PCT Filed: Jan. 26, 2018
(86) PCT No.: PCT/US2018/015370

§ 371 Date: Sep. 5, 2019

Related U.S. Application Data
(60) Provisional application No. 62/468,535, filed on Mar. 8, 2017.

(30) Foreign Application Priority Data
Apr. 11, 2017 (EP) 17165978.2

(51) Int. Cl. C08F 236/04; C09J 147/00; C09J 133/06; C09J 129/14; C08L 9/00; C08L 9/06; C08L 47/00; B60C 1/00; B60C 11/00

(52) U.S. Cl. CPC C08F 236/045; C09J 147/00; C09J 133/062; C09J 129/14; C08L 9/00; C08L 9/06; C08L 2205/03; B60C 1/0016; B60C 11/0008; C08F 2800/20; C08F 2810/00; C08L 2205/025; C08L 47/00

(57) ABSTRACT

This invention relates to a process for the preparation of a polar-functionalized resin composition comprising the steps of (A) contacting a polymer backbone with a reactive moiety to produce a polar-functionalized resin composition wherein the polymer backbone is derived from a feed comprising less than or equal to about 35 wt % components derived from piperylene; less than or equal to about 10 wt % components derived from amylene; less than or equal to about 10 wt % components derived from isoprene; less than or equal to about 55 wt % unreactive paraffins; and C9 homopolymer or copolymer resins, in the presence of a Friedel-Crafts or Lewis acid catalyst; and (B) recovering a polar-functionalized resin composition.

### CROSS-REFERENCE OF RELATED APPLICATIONS

This application claims the benefit of Provisional Application No. 62/468,535, filed Mar. 8, 2017 and European Application No. 17165978.2, filed Apr. 11, 2017, the disclosures of which are incorporated herein by their reference.

### FIELD OF THE INVENTION

This invention relates to a polar functionalized hydrocarbon resins and processes to produce thereof.

### BACKGROUND OF THE INVENTION

Acrylic adhesives are widely used as hot melt adhesives, heat activatable adhesives, and pressure-sensitive adhesives. In spite of the versatility of acrylic adhesives, there are certain substrates, such as certain types of automotive paints and low energy olefinic surfaces, to which typical acrylic adhesives do not adhere well. Efforts have been made to improve the adhesion of acrylic adhesives, i.e., develop more aggressive tack, to these types of surfaces; tackifying the base acrylic polymer is commonly practiced. Various types of tackifying resins such as phenol modified terpenes and rosin esters, are used as tackifiers.

Due to the high polarity of most pressure-sensitive acrylic adhesives and the presence of specific potential interactions between these adhesives and many tackifying resins, a limited selection of tackifying resins is available to the formulator. As a class, hydrocarbon-based tackifying resins, and especially hydrogenated hydrocarbon resins, are typically unsuitable for use in polar acrylic adhesives formulations due to their nonpolar character.

Rosin acid based tackifying resins and selected phenol-modified terpene and alpha-pinene based resins perform well in a variety of acrylic pressure-sensitive adhesives. However, some problems are still associated with the use of this limited range of tackifying resins in acrylic adhesives. Tackified acrylic pressure-sensitive adhesive formulations are often discolored or yellow. The yellow appearance of these tackified acrylic pressure-sensitive adhesives is a direct result of the distinct yellow tinge inherent in many of these tackifying resins. Therefore, a need exists, for polar functional hydrocarbon based tackifier which can be used as an alternative to terpene, rosin, and pinene based tackifiying resin.

Hydrocarbon resins have been used as modifiers for coatings (corrosion-resistant lacquer), reactive adhesives (two-pack epoxy or polyurethane) and integrated circuit encapsulants (epoxy resin based) as they are capable of plasticizing base polymers, relaxing the internal stress generated during the curing of base polymers, increasing the initial tack and adhesive strength of base polymers, and improving water resistance of base polymers. The modifying effects produced by such hydrocarbon resins however, have not been too satisfactory. In particular, they are not applicable to strongly polar base polymers because of their poor compatibility. Furthermore, they exhibit such low reactivity with base polymers as to reduce the mechanical strength, cohesion, adhesion, and rust-preventing capability of the base polymers after the curing of the coatings or adhesives or they migrate to the surface of the coatings or into the adhesive interface with the resultant discoloration and stickiness. Accordingly, an aim of this invention is to solve the above-mentioned issues of conventional hydrocarbon resins.

Another objective of the present invention is to synthesize high performance tire treads possessing exceptional traction and handling properties. For passenger tires, miscible hydrocarbon resins are typically used in tread compound formulations in order to increase traction characteristics. Although these resins increase overall traction, tread compounds formulated with these miscible resins tend to suffer from reduced traction and handling at high speeds or at high internal tire generated temperatures during hard driving. The foregoing and/or other challenges are addressed by the methods and products disclosed herein.

### SUMMARY OF THE INVENTION

This invention relates to a process for the preparation of a polar-functionalized resin composition comprising the steps of (A) contacting a polymer backbone with a reactive moiety to produce a polar-functionalized resin composition, wherein the polymer backbone is derived from a feed comprising less than or equal to about 35 wt % components derived from piperylene; less than or equal to about 10 wt % components derived from amylene; less than or equal to about 10 wt % components derived from isoprene; less than or equal to about 55 wt % unreactive paraffins; and C9 homopolymer or copolymer resins, in the presence of a Friedel-Crafts or Lewis acid catalyst; and (B) recovering a polar-functionalized resin composition.

### BRIEF DESCRIPTION OF THE FIGURES

FIGS. 1 to 5 depict the proton NMR charts for inventive polar functionalized hydrocarbon resins of the invention.

### DETAILED DESCRIPTION

Various specific embodiments of the invention will now be described, including preferred embodiments and definitions that are adopted herein for purposes of understanding the claimed invention. While the illustrative embodiments have been described with particularity, it will be understood that various other modifications will be apparent to and can be readily made by those skilled in the art without departing from the spirit and scope of the invention. For determining infringement, the scope of the “invention” will refer to any one or more of the appended claims, including their equivalents and elements or limitations that are equivalent to those that are recited.

The inventors have discovered that preparing a resin molecule and then treating it post-polymerization with a functional group to produce a polar functionalized hydrocarbon resin results in advantageous properties for the resin for use in water borne emulsion adhesives, sealants, and high performance tire tread applications.

The term “phr” means parts per hundred parts of rubber, and is a measure common in the art wherein components of a composition are measured relative to the total of all of the elastomer (rubber) components. The total phr or parts for all rubber components, whether one, two, three, or more different rubber components when present in a given recipe, is always defined as 100 phr. All other non-rubber components are ratioed against the 100 parts of rubber and are expressed in phr.

The term “interpolymer” means any polymer or oligomer having a number average molecular weight of 500 or more prepared by the polymerization or oligomerization of at least two different monomers, including copolymers, terpolymers, tetrapolymers, etc. As used herein, reference to monomers in an interpolymer is understood to refer to the as-polymerized and/or as-derivatized units derived from that monomer. The terms polymer and interpolymer are used broadly herein and in the claims to encompass higher oligomers having a number average molecular weight (Mn) equal to or greater than 500, as well as compounds that meet the molecular weight requirements for polymers according to classic ASTM definitions.

All resin component percentages listed herein are weight percentages, unless otherwise noted. “Substantially free” of a particular component in reference to a composition is defined to mean that the particular component comprises less than 0.5 wt % in the composition, or more preferably less than 0.25 wt % of the component in the composition, or most preferably less than 0.1 wt % of the component in the composition.

The term “elastomer,” as used herein, refers to any polymer or combination of polymers consistent with the ASTM D1566 definition, incorporated herein by reference. As used herein, the term “elastomer” may be used interchangeably with the term “rubber.”

### Functionalized Resin

The functionalized resin molecules of the present invention are prepared via post-reactor treating of a polymer backbone.

### Polymer Backbone

The phrase “polymer backbone” includes substituted or unsubstituted units derived from C₅ fraction homopolymer or copolymer resins, C₉ fraction homopolymer or copolymer resins, and combinations thereof. The term “resin molecule” or “resin” as used herein is interchangeable with the phrase “polymer backbone.”

Preferably, the polymer backbone comprises up to 100 mol % units derived from C₅ fraction homopolymer or copolymer resins, more preferably within the range from 5 to 90 mol % units derived from C₅ fraction homopolymer or copolymer resins, most preferably from 5 to 70 mol % units derived from C₅ fraction homopolymer or copolymer resins.

Preferably, the feed leading up to the polymer backbone comprises up to 35% piperylene components, up to 10% isoprene components, and between 5 to 10% amylene components by weight of the monomers in the monomer mix.

As used here, “C₉” refers to a petroleum distillate containing styrene, indene, alkyl derivatives, and combinations thereof.

Preferably, the polymer backbone has a refractive index greater than 1.5. Preferably, the polymer backbone has a softening point of 80° C. or more (Ring and Ball, as measured by ASTM E-28, with a heating/cooling rate of 10° C./min) more preferably from 80° C. to 150° C., most preferably 100° C. to 150° C.

Preferably, the polymer backbone has a glass transition temperature (Tg) (as measured by ASTM E 1356 using a TA Instruments model 2920 machine, with a heating/cooling rate of 10° C./min) of from −30° C. to 100° C.

Preferably, the polymer backbone has a Brookfield Viscosity (ASTM D-3236) measured at the stated temperature (typically from 120° C. to 190° C.) using a Brookfield Thermosel viscometer and a number 27 spindle of 50 to 25,000 mPa·s at 177° C.

Preferably, the polymer backbone comprises olefinic unsaturation, e.g., at least 1 mol % olefinic hydrogen, based on the total moles of hydrogen in the interpolymer as determined by ¹H-NMR. Alternatively, the polymer backbone comprises from 1 to 20 mol % aromatic hydrogen, preferably from 2 to 15 mol % aromatic hydrogen, more preferably from 2 to 10 mol % aromatic hydrogen, preferably at least 8 mol % aromatic hydrogen, based on the total moles of hydrogen in the polymer.

Examples of polymer backbones useful in this invention include Escorez® 8000 series resins sold by ExxonMobil Chemical Company in NDG, France. Further examples of polymer backbones useful in this invention include Arkon® series resins sold by Arakawa Europe in Germany Yet more examples of polymer backbones useful in this invention include the Eastotac® series of resins sold by Eastman Chemical Company in Longview, Tex.

### Process to Make the Polymer Backbone

The initial polymerization of steam-cracked petroleum hydrocarbons may be carried out in any conventional batch, semi-continuous or continuous fashion, all of which are well known in the petroleum resin art. The desired unsaturated hydrocarbon mixture is preferably contacted with small amounts of Friedel-Crafts catalyst such as boron trifluoride, aluminum chloride, aluminum bromide or the like. Amounts of such catalyst from 0.25 to 3.0% based on the unsaturated content of the feed are preferred. The catalyst may be employed in its solid state or in solutions, slurries or complexes. For example, boron trifluoride may be complexed with ether to form an etherate in accordance with techniques known in the art and the etherate may be employed as the catalyst.

The polymerization reaction is conducted with temperatures in the range of −30 to 90° C., and preferably from 0 to 75° C. In carrying out a continuous or batch operation, there is preferably employed an inert diluent such as benzene, naphtha, paraffins, cycloparaffins or other hydrocarbon fractions preferably boiling in the range of 70 to 125° C. The diluent may be employed in amounts from 5-75 by weight based on the olefin-containing feed. The diluent may be added first, last or at the same time as the feed. The reactor should comprise means for agitating the reaction mixture and the feed is preferably agitated during the addition of the catalyst and during the entire reaction time. Preferably the catalyst is added slowly over a period of 5 minutes to one hour or until the desired catalyst concentration has been reached. The temperature of the reaction mixture may be controlled by any known technique, a particularly preferred one is referred to normally as a pumparound system where the reaction mixture is continuously circulated through a temperature-controlling bath adapted to either heat or cool the mixture. After the start up on the reaction, the catalyst is continuously added at a rate to give the desired catalyst concentration together with fresh steam-cracked hydrocarbon feed. In a continuous system, a portion of the reaction mixture is continuously drawn off to a second vessel if desired to provide additional contact time and the product is withdrawn from the second vessel either batchwise or continuously. One technique for carrying out a batch reaction comprises forming a slurry of the catalyst in diluent and then slowly adding the steam cracked feed. The mixture is continuously agitated. If desired, only a portion of the aluminum chloride is added initially and the remainder after the reaction is started. The product mixture is then quenched, washed and stripped to give the final resin product. The reaction mixture may be quenched with an acid such as dilute sulfuric or phosphoric acid to stop the reaction. Water soluble non-ionic wetting agents such as alkyl polyethers, etc. may also be employed. These are all well known in the art. Subsequent to the quench, the product is usually water and/or alkali washed to remove any residual acidity. Subsequent to the washing, the resin solution is then stripped of diluent, unreacted hydrocarbon and any low molecular weight polymer to give the hard resin product. The stripping may be carried out in accordance with well-known techniques by vacuum or steam distillation. For example, hard resins are conveniently recovered by stripping to a bottoms temperature to about 270° C. at 2-5 mm Hg or the solution may be steam stripped for about 2 hours at 260° C. While the softening point may be raised by increasing the severity and/or time of stripping, this only results in relatively small increases in softening point and is accompanied by a loss in resin yield with a corresponding increase in undesired liquid polymer.

The polymer backbone used in the present invention may also be prepared by thermal polymerization methods known in the industry. The backbone may be prepared by thermally polymerizing steam cracked petroleum hydrocarbons in a thermal polymerization unit known in the art to achieve a desired molecular weight and composition. After processing in a thermal polymerization unit, the backbone may be nitrogen or stream stripped to prepare for functionalizing.

### Functionalization Process

After preparing the hydrocarbon resin polymer backbone, the resin is then functionalized. The functionalization of the backbone after polymerization is referred to herein as “post-polymerization” or “post-reactor.” The backbone is functionalized by reacting it with a reactive moiety. Preferably, the moiety is a polar compound selected from the following: pero-oxy acids, hydroboration agents, acetylation agents, thiols, and combinations thereof. Following functionalizing of the backbone with the reactive moiety, the percent of polar units in the polar-functionalized resin composition is in the amount of about 10 to about 15 mol % based on the composition.

The functionalized polymer produced by this invention can be used in water borne emulsion adhesives, reactive adhesives and sealants, and high performance tire tread compositions.

The high performance tire tread composition is formed by blending the polar-functionalized polymer produced by this invention with diene elastomer and inorganic filler.

Preferably, the silica treated functionalized polymer is present within the range from 5 to 100 phr, more preferably 10 to 50 phr. The diene elastomer may comprise a blend of two or more elastomers. The individual elastomer components may be present in various conventional amounts, with the total diene elastomer content in the tire tread composition being expressed as 100 phr in the formulation. Preferably, the inorganic filler is present within the range from 50 to 150 phr, more preferably 50 to 100 phr, most preferably 60 to 90 phr.

The water borne emulsion adhesive composition is formed by blending about 100 phr of acrylate/vinyl acrylate polymer, about 10-50 phr of the polar-functionalized polymer (preferably Resin C or D, described below), about 10-50 phr of additives, and about 5 to 30 phr of water.

The reactive adhesive or sealant composition is formed by blending about 5-100 phr of polar-functionalized polymer (preferably Resin B described below), about 5-75 phr of polymer or monomeric amine or anhydride to serve as a hardener, and about 10-200 phr of filler.

### Examples

### Resin A: Hydrocarbon Resin Backbone

The hydrocarbon resin used in the examples of the invention was prepared as followed. A C₅ monomer stream of piperylene, amylene, isoprene was introduced to 0.2 wt % AlCl₃, a Lewis acid catalyst, to undergo rapid polymerization at a reaction temperature of 0° C. to form 1, 2 or 1, 4 addition product. The polymerization can be controlled to produce more 1, 2 or 1, 4 product with the proper choice of Lewis acid, concentration of Lewis Acid, and reaction temperature. The polymerization was quenched with isopropanol and the product was distilled with nitrogen to a resin yield of 30%. All manipulations were performed under inert atmosphere in a nitrogen-purged glove box. Solvents were used as received (anhydrous) or dried over 3 Å molecular sieves, and degassed by sparging with nitrogen. The resin was characterized for proton NMR spectroscopy (% Aliphatic Proton: 86%; % Olefinic Proton: 14%) and GPC (number average molecular weight: 2100 g/mole; weight average molecular weight: 14,000 g/mole). The resultant hydrocarbon resin is referred to herein as Resin A.

Resin A was then functionalized with various polar functional groups (epoxy, hydroxyl, acetate, and silicon), as described below.

### Resin B: Epoxy-Functionalized Resin

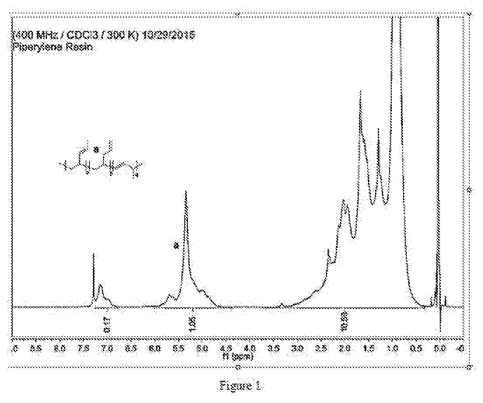

1 g of Resin A was dissolved in 25 mL of dichloromethane (DCM 40 mg/mL), and placed in a round bottom flask equipped with a dropping funnel and a condenser. The meta-chloroperbenzoic acid (mCPBA, 1.0 g) was dissolved in 20 ml of CH₂Cl₂ and added drop-wise to a stirred solution of the polymer maintained at 0° C. After the addition was complete the reaction mixture was warmed to room temperature and allowed to stir for 24 h, after which the mixture was quenched with aqueous NaHCO₃ and washed repeatedly with water. The organic solution was isolated and dried over MgSO₄. The Olefinic resonance at 5.3-5.5 ppm (a) has decreased and appearance of new peak at 4.3-3.5 ppm (b & c) suggest ˜80% conversion of olefins to epoxides, as shown in FIG. 1.

### Resin C: Hydroxyl-Functionalized Resin

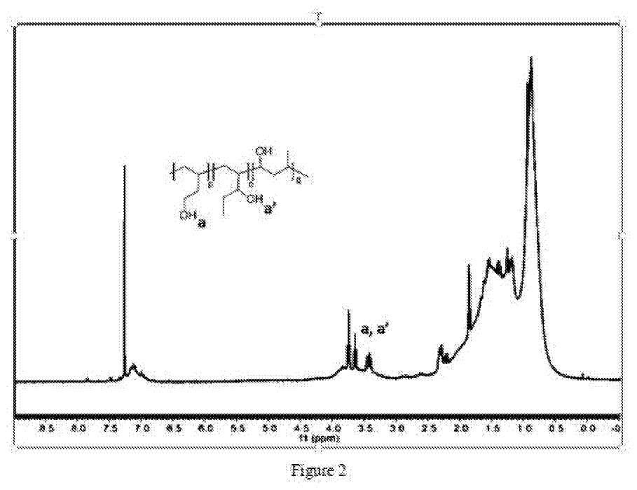

In an inert atmosphere glove box, a 20 mL vial was charged with a solution of Resin A in THF (0.14 mg/mL, 1.3 mL 182 mg, 2.9 mmol olefins), followed by borane (BH₃.THF (0.6 mL, 1 M, 7 mmol)), and the mixture was allowed to stir at ambient temperature (about 23.5° C.). After 22 h, the mixture was diluted with aqueous potassium hydroxide, KOH (0.5 mL, 3 M), and hydrogen peroxide (H₂O₂, 0.1 mL, 30% in H₂O) was added. The mixture was heated to 50° C. for 4 h, after which the mixture was cooled to room temperature, diluted with diethyl ether Et₂O (10 mL), extracted with water (3×5 mL), dried over Na₂SO₄, and the solvent removed by a stream of nitrogen to afford a gummy off-white product. ¹H NMR (400 MHz, Chloroform-d) δ 7.36-6.81 (m, aryl, 1H), 4.32-3.05 (m, CH₂OH/CHOH, 2.33H), 2.69-0.25 (m, aliphatic, 18H), as shown in FIG. 2.

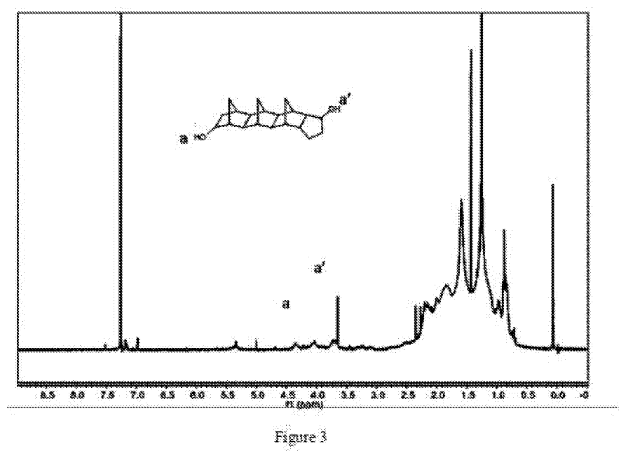

The following comparative example describes a methodology to prepare oligohydroxy cyclopentadiene. In an inert atmosphere glove box, a 20 mL vial was charged with a solution of oligocyclopentadiene resin (56 mg, 0.2 mmol), followed by anhydrous THF (2 mL), and BH3.THF (0.4 mL, 1 M, 0.5 mmol), and the mixture was allowed to stir at ambient temperature (about 23.5° C.). After 22 h, the mixture as diluted with aqueous KOH (0.5 mL, 3 M), and 0.1 mL of 30% H₂O₂ was added. The mixture was heated to 50° C. for 4 h, at which point the mixture was diluted with Et₂O (10 mL), extracted with water (3×5 mL), dried over Na₂SO₄, and the solvent removed by a stream of nitrogen to afford a white powder. ¹H NMR (400 MHz, Chloroform-d) δ 5.17 (m, olefins, 1H), 4.63-3.58 (m, CHOH, 51H), 2.88-0.46 (m, aliphatic, 1691H), as shown in FIG. 3. The inventors observed complete conversion of the olefinic groups to alcohols in both oligopiperylene resins and oligocyclopentadiene resins under mild conditions using BH3.THF, and subsequent oxidation using H₂O₂ under alkaline conditions without intermediate purification. NMR confirms complete conversion, and does not suggest any unwanted side reactions.

### Resin D: Acetate-Functionalized Resin

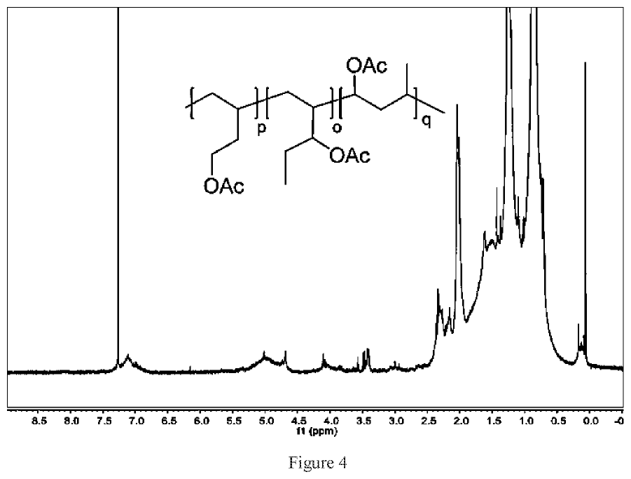

An 8 mL vial was charged with a solution of Resin C in CDCl₃ (10 mg, 0.2 mmol, 0.3 M), followed by acetyl chloride (0.1 mL, 0.12 g, 0.15 mmol), and triethylamine Et₃N (0.2 mL, 0.15 g, 1.5 mmol), and the mixture was allowed to stir at ambient temperature (about 23.5° C.). After 24 h, the mixture was diluted with Et₂O (10 mL), extracted with water (3×5 mL), dried over anhydrous Na₂SO₄, and the solvent removed by a stream of nitrogen to afford an off-white gum. ¹H NMR (400 MHz, Chloroform-d) δ 7.26 (s, aromatic, 9H), 5.53-4.54 (m, CH2OAc/CHOAc 1H), 4.27-3.20 (m, acetyl CH3, 2H), 2.65-0.41 (m, aliphatic, 246H), as indicated in FIG. 4.

### Resin E: Silicon-Functionalized Resin

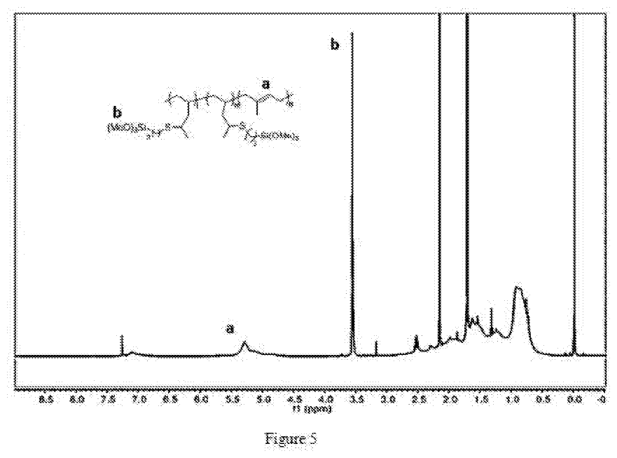

In an inert atmosphere glove box, a 20 mL vial was charged with Resin A in THF (0.14 mg/mL, 3 mL 420 mg, 6.2 mmol olefins), and diluted with toluene (3 mL). To this mixture (3-mercaptopropyl)trimethoxysilane (0.99 g, 5 mmol) was added, followed by Azobisisobutyronitrile AIBN (0.4 g, 2 mmol), and the mixture was heated to 70° C. After 12 h, the volume was reduced under a stream of dry N₂ and the concentrated solution was precipitated with MeOH, and the resulting solid washed with acetone to provide an off-white gum. ¹H NMR (400 MHz, Chloroform-d) δ 7.18 (br s, aromatic, 1H), 5.29 (br s, olefins, 3H), 3.55 (br s, SiOCH3, 4H), 1.93 (br m, aliphatic, 12H), as indicated in FIG. 5. Our initial thioester derivative was prepared using (3-mercaptopropyl)trimethoxy silane, a thiol-filler coupling agent, under thermally initiated thiol-ene reaction conditions. Under the attempted conditions, only partial conversion is achieved. However, for substituted olefins, complete conversion often requires a large excess of the thiol and radical initiator, as demonstrated in past patent memos for oligocyclopentadiene resins. In addition, the ability to tune the conversion reliably for thiolether derivatives of these resins provides the opportunity to produce multifunctional materials.

This invention describes synthesis of polar functional hydrocarbon tackifiers via post polymerization route. The epoxy, hydroxyl and acetate functional tackifiers will improve compatibility and thus provides better adhesion, corrosion prevention, and water resistance in the fields of coatings, adhesives, and sealants. The silicone functional hydrocarbon tackifiers can be used for high performance tire treads. The invention is not limited to the use of epoxy, hydroxyl, acetate, and silicon functional groups.

### INDUSTRIAL APPLICABILITY

The compositions of the invention may be extruded, compression molded, blow molded, injection molded, and laminated into various shaped articles including fibers, films, laminates, layers, industrial parts such as automotive parts, appliance housings, consumer products, packaging, and the like.

In particular, the compositions comprising the resin are useful in components for a variety of tire applications such as truck tires, bus tires, automobile tires, motorcycle tires, off-road tires, aircraft tires, and the like. Such tires can be built, shaped, molded, and cured by various methods which are known and will be readily apparent to those having skill in the art. The compositions may be fabricated into a component of a finished article for a tire. The component may be any tire component such as treads, sidewalls, chafer strips, tire gum layers, reinforcing cord coating materials, cushion layers, and the like. The composition may be particularly useful in a tire tread.

The compositions comprising the resin of the present invention are useful in a variety of applications, particularly tire curing bladders, inner tubes, air sleeves, hoses, belts such as conveyor belts or automotive belts, solid tires, footwear components, rollers for graphic arts applications, vibration isolation devices, pharmaceutical devices, adhesives, caulks, sealants, glazing compounds, protective coatings, air cushions, pneumatic springs, air bellows, accumulator bags, and various bladders for fluid retention and curing processes. They are also useful as plasticizers in rubber formulations; as components to compositions that are manufactured into stretch-wrap films; as dispersants for lubricants; and in potting and electrical cable filling and cable housing materials.

The compositions comprising the resin may also be useful in molded rubber parts and may find wide applications in automobile suspension bumpers, auto exhaust hangers, and body mounts. In yet other applications, compositions of the invention are also useful in medical applications such as pharmaceutical stoppers and closures and coatings for medical devices.

Certain embodiments and features have been described using a set of numerical upper limits and a set of numerical lower limits. It should be appreciated that ranges from any lower limit to any upper limit are contemplated unless otherwise indicated. Certain lower limits, upper limits, and ranges appear in one or more claims below. All numerical values are “about” or “approximately” the indicated value, and take into account experimental error and variations that would be expected by a person having ordinary skill in the art.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A process for the preparation of a polar-functionalized resin composition comprising the steps of:
(A) contacting a polymer backbone with a reactive moiety to produce a polar-functionalized resin composition, wherein the polymer backbone is derived from a feed comprising:
(i) less than or equal to about 35 wt % components derived from piperylene;
(ii) less than or equal to about 10 wt % components derived from amylene;
(iii) less than or equal to about 10 wt % components derived from isoprene;
(iv) less than or equal to about 55 wt % unreactive paraffins; and
(v) C9 homopolymer or copolymer resins in the presence of a Friedel-Crafts or Lewis acid catalyst; and
(B) recovering a polar-functionalized resin composition.

2. The process of claim 1, wherein the percent of polar units in the polar-functionalized resin composition is in the amount of about 10 to about 15 mol % based on the composition.

3. The process of claim 1, wherein the reactive moiety is selected from one or more pero-oxy acids, hydroboration agents, acetylation agents, thiols, and combinations thereof.

4. The process of claim 1, wherein the Friedel-Crafts catalyst is aluminum chloride.

5. The process of claim 1, wherein the Lewis acid catalyst is selected from aluminum chloride, boron trifloride, ethylaluminium dichloride, titanium tetrachloride, and combinations thereof.

6. A polar functionalized resin composition prepared by the method according to claim 1.

7. A reactive adhesive, a water borne adhesive, or a tire tread composition comprising the polar-functionalized resin composition of claim 6.

8. The tire tread composition of claim 7, comprising:
(i) about 5 to about 100 phr of the polar-functionalized resin composition;
(ii) about 100 phr of a diene elastomer; and
(iii) an inorganic filler within the range from about 50 to about 150 phr.

9. The tire tread composition of claim 7, wherein the polar-functionalized resin composition is present within the range from about 20 to about 50 phr.

10. The tire tread composition of claim 8, wherein the inorganic filler comprises silica.

11. The tire tread composition of claim 8, wherein the diene elastomer is selected from at least one of natural rubber, polybutadiene rubber, polyisoprene rubber, styrene-butadiene rubber, isoprene-butadiene rubber, high cis-polybutadiene, ethylene-propylene rubber, ethylene-propylene-diene rubber, nitrile rubber, butyl rubber, halogenated butyl rubber, branched (“star-branched”) butyl rubber, halogenated star-branched butyl rubber, poly(isobutylene-co-p-methylstyrene), brominated butyl rubber, chlorinated butyl rubber, star-branched polyisobutylene rubber, and mixtures thereof.

12. The tire tread composition of claim 11, wherein the diene elastomer comprises a mixture of polybutadiene rubber and styrene-butadiene rubber.

13. The reactive adhesive of claim 7, comprising:
(i) about 5 to about 100 phr of the polar-functionalized resin composition;
(ii) about 5 to about 75 phr of polymeric; and
(iii) about 5 to about 30 phr of water.

14. The reactive adhesive of claim 13, where in the reactive moiety of the polar-functionalized resin composition is a per-oxy acid.

15. The water borne adhesive of claim 7, comprising:
(i) about 10 to about 50 phr of the polar-functionalized resin composition;
(ii) about 100 phr of acrylate/vinyl acetate polymer;
(iii) about 10 to about 50 phr of additive; and
(iv) about 5 to about 30 phr of water.

16. The water borne adhesive of claim 15, where in the reactive moiety of the polar-functionalized resin composition is selected from one or more hydroboration agents, acetylation agents, and combinations thereof.
